(19) United States
(12) Patent Application Publication
(10) Pub. No.: US 2010/0121522 A1
(43) Pub. Date: May 13, 2010

(54) METHOD AND APPARATUS FOR SHARING TRAFFIC INFORMATION

(75) Inventors: OURI WOLFSON, Highland Park, IL (US); Masaaki Tanizaki, Kokubunji-Shi (JP)

Correspondence Address: AKERMAN SENTERFITT, P.O. BOX 3188, WEST PALM BEACH, FL, 33402-3188, US

(73) Assignee: THE BOARD OF TRUSTEES OF THE UNIVERSITY OF ILLINOIS, Urbana, IL (US)

(21) Appl. No.: 12/610,912

(22) Filed: Nov. 2, 2009

Related U.S. Application Data
(60) Provisional application No. 61/111,493, filed on Nov. 5, 2008.

(51) Int. Cl. G06F 19/00; G01S 19/13

(52) U.S. Cl. 701/33; 342/357.09; 701/119

(57) ABSTRACT

A system that incorporates teachings of the present disclosure may include, for example, a communication device having a controller to receive from a system a broadcasted vehicle velocity, detect that a difference between a velocity of a vehicle carrying the communication device and the broadcasted vehicle velocity exceeds a threshold, and determine from a random policy whether to transmit the velocity of the vehicle to the system. Additional embodiments are disclosed.

### CROSS REFERENCE TO RELATED APPLICATIONS

The present application claims the priority of U.S. Provisional Patent Application No. 61/111,493 filed Nov. 5, 2008. All sections of the aforementioned application are incorporated herein by reference.

### STATEMENT AS TO FEDERALLY SPONSORED RESEARCH

This invention was made with government support under grants DGE-0549489, O11-0611017, 0513736, and 0326284 awarded by the National Science Foundation. The government has certain rights in this invention.

### FIELD OF THE DISCLOSURE

The present disclosure relates generally to traffic information management, and more specifically to a method and apparatus for sharing traffic information.

### BACKGROUND

Floating Car Data (FCD) techniques have been researched and developed as shown by reference [1]. FCD is one way to gather traffic information using floating cars as sensor nodes which have a location detecting device such as a Global Positioning System (GPS) or a communication device with GPS such as a cellular phone. Traffic-information services based on FCD have been provided in Japan and the EU (see [2], [3]).

In traffic information sharing systems using FCD techniques, vehicles can wirelessly transmit a measured velocity to a computing device such as a server. The server can manage real time traffic information of each road segment and can deliver the traffic information to vehicles in the service area by continuously broadcasting the current speed on each road segment. Vehicles receiving the traffic information can calculate their travel time and also the minimum-time route to their destination based on the road network data and the broadcasted traffic information.

### BRIEF DESCRIPTION OF THE DRAWINGS

FIG. 1 depicts an illustrative embodiment of a sample situation of a randomized policy;

FIG. 2 depicts an illustrative embodiment of a simulation procedure;

FIG. 3 depicts an illustrative embodiment of a speed transition by simulation;

FIG. 4 depicts an illustrative embodiment of a threshold T and average error (U=0.05);

FIG. 5 depicts an illustrative embodiment of a threshold T and total messages during a 2 hour period;

FIG. 6A depicts an illustrative embodiment of a difference in communication cost between a deterministic policy and randomized policy as a function of an average error;

FIG. 6B depicts an illustrative embodiment of a communication cost savings afforded by a randomized policy as a percent of a total cost;

FIG. 7 depicts an illustrative embodiment of an Floating Car Data (FCD) communication system; and

FIG. 8 depicts an illustrative diagrammatic representation of a machine in the form of a computer system within which a set of instructions, when executed, may cause the machine to perform any one or more of the methodologies disclosed herein.

### DETAILED DESCRIPTION

One embodiment of the present disclosure entails a communication device having a controller to receive from a system a broadcasted vehicle velocity, detect that a difference between a velocity of a vehicle carrying the communication device and the broadcasted vehicle velocity exceeds a threshold, and determine from a random policy whether to transmit the velocity of the vehicle to the system.

One embodiment of the present disclosure entails a computing device having a controller to broadcast to a plurality of vehicles an observed vehicle velocity associated vehicles traveling on at least one road segment, receive a velocity of a vehicle traveling the at least one road segment from a communication device responsive to detecting that a difference in the velocity of the vehicle and the observed vehicle velocity exceeds a threshold and satisfies a random policy used by the communication device, and update the observed vehicle velocity according to the received velocity of the vehicle.

One embodiment of the present disclosure entails a computer-readable storage medium having computer instructions to transmit a measured velocity of a vehicle responsive to a random policy.

One embodiment of the present disclosure entails a computer-readable storage medium having computer instructions to receive from a device a measured velocity of a vehicle responsive to said device detecting that a difference between the measured velocity of the vehicle and a broadcasted vehicle velocity exceeds a threshold, and a random policy directs said device to transmit the velocity of the vehicle.

In Floating Car Data (FCD) applications, it can be necessary to update a traffic information database (residing on a server) by a significant number of transmissions from vehicles. However, in metropolitan areas with millions of vehicles, FCD related communications can be costly and can exhaust the resources of an FCD server processing these transmissions. To mitigate this issue, one could indiscriminately reduce the number of FCD transmissions from vehicles to the server. However, this approach can lower the accuracy of traffic information provided by the server to vehicles.

It is however observed that an FCD traffic information sharing system can have redundant transmissions. The reason is that multiple vehicles going through a road segment at around the same time are likely to measure the same speed and transmit the same information to the server. This problem increases in severity with a server delay (i.e. the time it takes from the transmission of a velocity update by a vehicle to the server, until this update is propagated to the vehicles in this service area).

To address the problem, the present disclosure discloses a randomized update policy in which the vehicles transmit their measured speed with a certain probability smaller than 1. In other words, to determine whether or not to send the measured speed to the server each vehicle can be directed, for example, to toss a coin with probability p, and transmit the speed only if heads comes up.

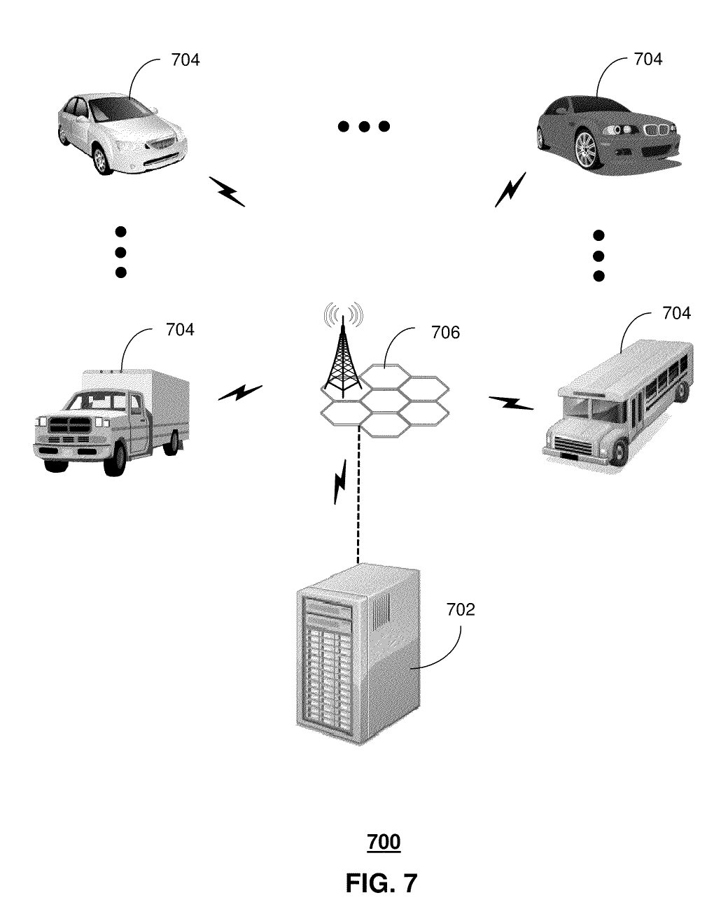

For illustration purposes, the disclosure below will make reference to the embodiments of FIG. 7 to illustrate an FCD communication system 700. The FCD communication system 700 can comprise a server 702 communicatively coupled to FCD-capable vehicles 704 (herein FCD 704) by way of a wireless communication medium 706. The FCDs 704 can provide GPS-related data by way of an embedded GPS system in the vehicle or a cellular phone with a GPS function carried by a user in the vehicle. The GPS-related data can be coordinate data (e.g., longitude and latitude data), and/or vehicle speed data. In the case where only coordinate data is provided, the server 702 can determine speed of travel from multiple instances of coordinate data from the same FCD 704. The wireless communication medium 706 can represent a cellular base station, WiMAX communications, or other present or next generation wireless communication system.

An important problem regarding the randomized update policy is how to determine the transmission probability p. To solve this problem, the present disclosure considers how to achieve the maximum accuracy by the minimum number of data transmissions from FCDs 704 to the server 702. The present disclosure further quantifies a trade-off relationship between the transmission cost in system 700 and the accuracy of information shared by clients. The present disclosure also discloses an Information Cost Model.

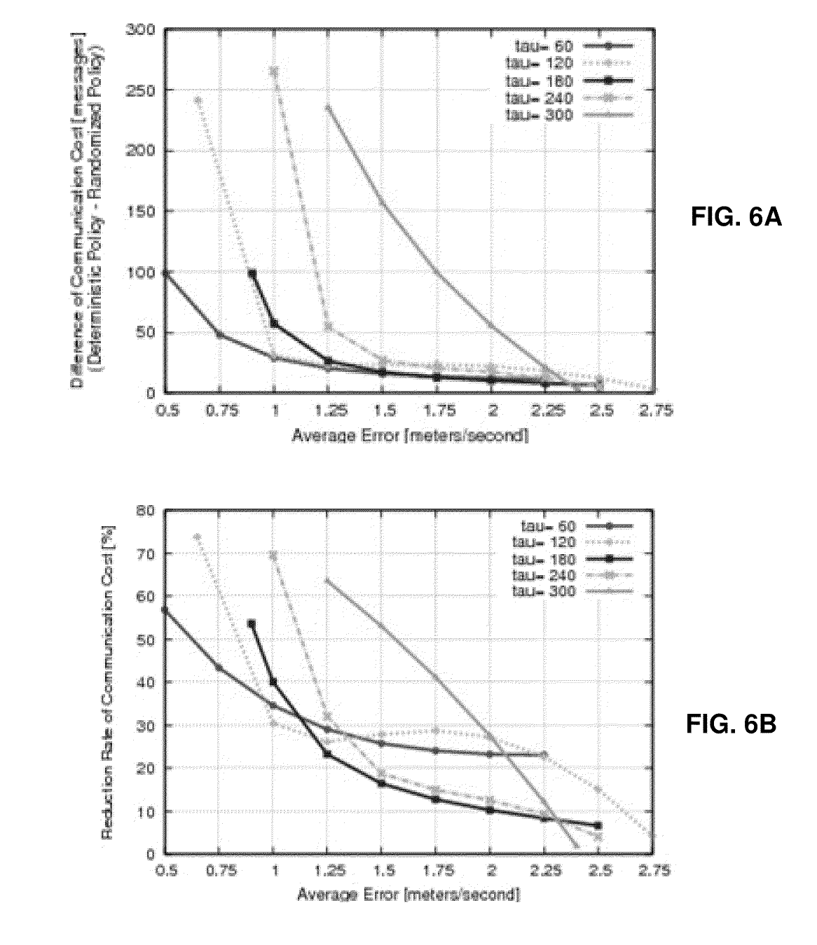

The randomized policy is evaluated and compared with a deterministic policy by simulation. For illustration purposes, the simulation uses real traffic data from Chicago highways. The main result (FIG. 6) shows that for a given accuracy (or error), the randomized policy uses fewer transmissions than the deterministic policy. More precisely, the communication savings of the randomized policy can be as high as 72%, with the actual percentage depending on the server delay and the accuracy.

FCD Update Policies

In this section the present disclosure describes two policies by which FCD-capable vehicles 704 can update the server 702 by way of the deterministic policy and the randomized one.

Deterministic Policy

In order to explain a traffic information sharing system such as system 700 using the FCD technique, a system is assumed to operate as follows. The server 702 and FCD vehicles 704 can have the same map that consists of road segments, identified individually by an identification (ID). At each point in time, each road segment has a velocity vₘ that represents the current speed on the segment. Each FCD vehicle 704 has a table storing the velocity of each road segment, and so does the server 702. The vehicles traversing a segment know vₘ on that segment, and they inform the server 702 so it can broadcast it to all vehicles. Clearly, this velocity is of interest to vehicles that are not on the road segment. Due to synchronization issues, the broadcasted velocity, denoted v_{b}, is not always identical to the current velocity vₘ; sometimes it lags behind. Observe also that the velocities are given at a road-segment granularity. For all practical purposes such granularity is sufficient.

In order to update the vehicles' velocity information dynamically, the server 702 continuously broadcasts the velocity v_{b} of each segment. v_{b} is updated by transmissions from the FCD vehicles 704 traversing that segment. Each vehicle receives a broadcasted velocity on each road segment, and also sends a velocity vₘ to the server 702 for each road segment it traverses. vₘ is the average velocity on the road segment, as measured when the vehicle reaches the end of the segment. vₘ is computed by simply dividing the length of the road segment by the time it took the vehicle to traverse the segment.

The present disclosure assumes that the FCD vehicles 704 have a location detecting device such as GPS, a transmission device such as a cellular phone, and a broadcast receiver such as a radio receiver. The location detecting device is used for determine the position on a road segment in the map data. To simplify the explanation, the present disclosure focuses on a scenario involving only one road segment in the map.

In order to prevent small differences in velocity from being transmitted to the server 702, a velocity threshold is used (see [4]). The present disclosure denotes by T the velocity threshold, and then the transmission rule that permits the vehicles to send vₘ to the server is expressed as follows:

|vₘ−v_{b}|≧T (1)

In other words, the transmission rule indicates that the vehicle transmits vₘ to the server 702 if and only if the difference between the broadcasted velocity (received from the server and stored in the vehicle for the road segment) and the measured velocity exceeds T. The present disclosure calls the policy using a particular threshold T as the deterministic policy.

Randomized Policy

In order to motivate the randomized policy, the present disclosure explains the presence of redundancy in the deterministic policy. Intuitively, redundancy can be a result of a lag between a point in time t when the first vehicle detects that the threshold T is exceeded and transmits its vₘ to the server 702, and another point in time when the transmitted speed vₘ becomes the speed v_{b} broadcasted by the server 702. This lag can be called the server delay. During the server delay, all FCD vehicles 704 that pass through the end of the road segment will have the transmission rule satisfied, and thus transmit (almost) the same vₘ to the server 702 (assuming that the average velocity on the road segment is stable during the server delay). It can be further observed that if the server delay is zero, then the FCD vehicles 704 that cross the end of the road segment after time t will have the new velocity, and thus they will not transmit anything to the server 702, thereby eliminating the redundancy. However, a zero-delay server is unlikely.

In order to solve this problem, the present disclosure describes a randomized policy which uses a randomization function for avoiding redundant transmissions. The randomized policy can utilize similar principles as the deterministic policy, except that when the transmission rule is satisfied, instead of transmitting vₘ to the server 702 with probability 1, the randomized policy does so with some given transmission probability p.

How does this help? Suppose that ten FCD vehicles 704 run through the end of a segment during the server delay τ, and the transmission rule is satisfied (with the previous v_{b}) for each one of these vehicles. If p= 1/10, then the expected number of FCD vehicles 704 that will transmit vₘ to the server 702 is one; so there are no redundant transmissions.

It is observed that in the above discussion an implicit assumption is made that the time interval between two consecutive times when the threshold T is exceeded is not higher than the server delay; otherwise the system thrashes, indicating that the threshold T is too low.

It is further observed that if p is too small, then there will not be enough updates and the accuracy of system 700 will decrease. On the other hand if p is too large there will be redundant transmissions. The question now is what should p be and how should it be determined. Intuitively it is clear that the optimal probability p depends on factors such as: 1) K, the number of FCD vehicles 704 running through the end of the segment during server delay τ, 2) the number of time units between two consecutive times the threshold is exceeded, 3) the threshold T, and so on. Furthermore, some of these parameters change dynamically, thus the optimal probability changes dynamically. In the randomized policy the following information can be continuously broadcast by the server 702 for each road segment:
the optimal probability p for each road segment (computed by the server)
the current speed v_{b} and
u: The uncertainty of v_{b} for the segment. This value may be the velocity threshold T, or the free flow speed V.
   Below the present disclosure explains how the server chooses one of these two values.

Definition of Information Cost Model

Compared to the deterministic policy, the randomized policy increases the uncertainty in the FCD information system 700, and decreases the communication cost. In one embodiment, the randomized policy can be a set of policies, one for each transmission probability p.

In order to estimate an optimal probability p for the randomized policy, one can quantify the trade-off between the communication cost and the uncertainty cost. The following discussion pertains to a particular road segment.

A total information cost COST₁ of an update policy is defined to be the sum of the communication cost COST_{C} (expressing the total amount of transmitted data) and the uncertainty cost COSTᵤ (expressing the inaccuracy (or uncertainty) of the information about the road segment).

COST₁=COST_{C}+COSTᵤ (2)

The communication cost can be defined as the number of transmissions from an FCD vehicle 704 to the server 702 per time unit. The unit cost of one transmission is set to 1 to simplify the problem.

Suppose that the server 702 continuously broadcasts the current speed v_{b} on each road segment along with a threshold T. This can indicate to vehicles currently on the road segment that if they experience a velocity vₘ that differs from v_{b} by a value higher than T, they should update the server. T indicates to the vehicles currently outside the road segment, i.e. the ones interested in the velocity information for the road segment that the velocity may change within T without the server broadcasting such change. Thus T is the uncertainty for the road segment.

As the uncertainty increases, the communication cost decreases since the threshold will be reached less frequently. It is also follows that the uncertainty of the segment may change over time, if, for example, the threshold T changes.

Let U be the cost of a unit of uncertainty per time unit. If the uncertainty on the road segment is T over a time interval of length I, then the uncertainty cost for the segment over the interval can be U*T*I. U is given in messages. So, for example, if U=0.01 this means that the system designer is willing to pay 0.01 transmissions from an FCD vehicle 704 to the server 702 in order to reduce the segment-uncertainty by one unit (e.g. from T to T−1), during a single time unit.

Information Cost of Randomized Policy

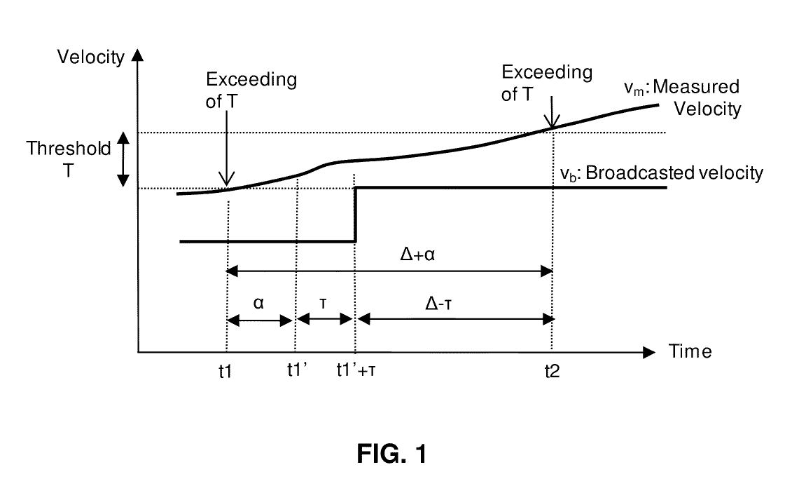

This subsection analyzes the information cost of the randomized policy. In order to do so, consideration is given to the period of time between two consecutive times, t1 and t2, when the transmission threshold T is exceeded (see FIG. 1).

The first exceeding of the threshold T on an FCD vehicle 704 occurs at t1. However, the transmission does not occur immediately, because the result of the randomization function may be false. Furthermore, some of the subsequent FCD vehicles 704 running after the first FCD vehicle 704 don't send their measured velocity because the result of the randomization function is not true until t1′. The period of time in which the FCD vehicles 704 run through the end of a road segment without sending the measured velocity even though the transmission rule is satisfied is denote by α. In other words, the FCD vehicle 704 that runs through the end of the segment at t1′ is the first after t1 to transmit the updated vₘ to the server 702.

Subsequently, the updated v_{b} is broadcasted to the all vehicles after the server delay τ, i.e. at time t1′+τ. Between this time and t2 FCD vehicles 704 do not send their velocity to the server 702, because the transmission rule is not satisfied.

Under these circumstances, the expected communication cost during the time period Δ+α is the following: (the number of FCD vehicles K that run through the end of the segment during the server delay τ)×(the transmission probability p). Therefore, COST_{C}, the communication cost per time unit is:

$${COST}_{c} = \frac{pK}{Δ + α} \qquad ( 3 )$$

The uncertainty cost is computed as follows. Consider the period of time of length α+τ, starting from t1 and ending at t1′+τ. Due to randomization and server delay, during this period of time the server 702 does not know the measured speed. Therefore it assumes the maximum uncertainty, V, which is the free flow speed; for example, V can be taken to be 60 mph. Thus, for each time unit during this period, the cost of the uncertainty is UV.

Now consider the period of time of length Δ−τ, starting from t1′+τ and ending at t2. During this period the FCD vehicles 704 know that the uncertainty is T (because this is the value broadcasted by the server 702) and this knowledge is accurate. Thus the uncertainty cost during this period is 2TU for each time unit. Thus COSTᵤ is as follows:

$${COST}_{u} = \frac{UV ( α + τ ) + U * 2 T * ( Δ - τ )}{Δ + α} \qquad ( 4 )$$

The above discussion of the uncertainty cost assumes that the server 702 knows the values of α, τ, and Δ at time t1. τ is estimated by the load on the server 702. Since Δ changes dynamically, the server 702 predicts its next value based on a sliding window of the last values for these parameters. For example, the server 702 saves the last five values for each one of these two parameters (τ and Δ), and takes the next one to be the average of these. The parameter a is calculated as explained in the next subsection.

Thus, the server 702 estimates the uncertainty of v_{b}, denoted as u, for each time unit between t1 and t2. The estimate is V between t1 and t1′+τ, and T*2 between t1′+τ and t2.

The information cost is expressed by the addition of (3) and (4) as follows:

$${COST}_{I} = \frac{pK + UV ( α + τ ) + 2 UT ( Δ - τ )}{Δ + α} \qquad ( 5 )$$

Optimum Probability

In order to determine an optimum probability of the randomized policy, a minimum of the cost equation (5) is determined as a function of the probability p.

In order to do so, one can first express a as a function of p. α is the expected length of the period of time starting when an FCD vehicle 704 exceeds the threshold for the first time, and ending when an FCD vehicle 704 transmits the revised velocity to the server 702. Therefore, α is calculated as the sum of the lengths (in time units) s between two consecutive FCD vehicles 704, multiplied by the probability p*(1−p)ⁱ⁻¹. It models the situation where (i−1) consecutive vehicles get “false” as a result of the coin toss, and the i-th vehicle gets “true”. Specifically,

$$α = s * ( \begin{matrix}p * 0 + p ( 1 - p ) * 1 + … + \\ {p ( 1 - p )}^{i} * i + …\end{matrix} ) s * p {\sum }_{i = 0}^{∞} {( 1 - p )}^{i} i$$

It can be shown that the following formula holds for each real number q, where 1>|q|:

$${\sum }_{i = 0}^{∞} {q}^{i} i = \frac{q}{{( 1 - q )}^{2}}$$

Hence, by substitution of (1−p) for q:

$$α = sp * \frac{1 - p}{{p}^{2}} = \frac{s ( 1 - p )}{p}$$

Then, by substituting the above expression for a in equation (5) we obtain the cost as a function of probability p, as follows:

$$f ( p ) = \frac{{K}_{p}^{2} + \{ VU ( τ - s ) + 2 TU ( Δ - τ ) \} p + VsU}{( Δ - s ) p + s}$$

Next, p can be found where f′(p)=0 during (0,1], and show that f″(p)>0. Thus p is determined for which f(p) is minimum.

$${f}^{′} ( p ) = \frac{( Δ - s ) {K}_{p}^{2} + 2 Ksp + ( V - 2 T ) ( τ - Δ ) sU}{{\{ ( Δ - s ) p + s \}}^{2}}$$

One can solve for the case where f′(p)=0 using the quadratic formula as follows:

$$p = \frac{- Ks \pm \sqrt{{K}^{2} {s}^{2} + ( Δ - s ) ( Δ - τ ) ( V - 2 T ) KsU}}{( Δ - s ) K}$$

Because p is between 0 and 1, p which satisfies f′(p)=0 is:

$$p = \frac{- Ks \pm \sqrt{{K}^{2} {s}^{2} + ( Δ - s ) ( Δ - τ ) ( V - 2 T ) KsU}}{( Δ - s ) K} \qquad ( 6 )$$

And there are restrictions where 0<p<1 as follows:

$$U < \frac{( Δ + s ) K}{( Δ - τ ) ( V - 2 T ) s} , Δ > s , Δ > τ and T < V / 2 \qquad ( 7 )$$

If these restrictions do not hold, then it is possible that the optimal p comes out to be a number that is bigger than 1 or smaller than 0. If so, then such number is turned into a probability of 1 (in case the number is bigger than 1), or a small probability close to 0 (if the number is negative). Overall, the probability p shown in equation (6) is the value which minimizes the cost of information expressed in equation (5).

For the rest of this section one can consider the two parameters K and s in equation (6) above. One cannot obtain these values from the FCD vehicles 704 directly. To determine these parameters one can use a model giving the relationship between the velocity and the traffic flow (Greenshield's model [12]). This model is widely cited (see [13]). The relationship is given by equation (8). In this equation, r is the traffic flow, i.e., how many FCD vehicles 704 pass a point per time unit; thus r is the inverse of s. d is the traffic jam density, i.e., how many FCD vehicles 704 fit per unit-length. vₘ is the velocity. V is free flow speed of FCD vehicles 704.

r=d*vₘ(1−vₘ/V) (8)

Equation (8) can indicate that the flow (i.e. 1/s) is determined based on d, vₘ and V. These parameters are obtained as follows. vₘ is known from the FCD vehicle 704. d and V can be determined a priori by the least square method, using equation (8); the determination is based on real traffic data, which includes (velocity, flow) pairs for each minute. Now, given s and the server delay, it is easy to compute K.

Evaluation by Simulation

In order to compare the efficiency of the randomized policy with the deterministic one, a simulation system was developed using real traffic data. In this section describes the simulation environment, and the results of the comparison.

The Traffic Data for Simulation Input

Highway traffic speed information provided by GCM travel web site [15] was used to evaluate the deterministic and randomized policies. This web site has been operated by Illinois, Indiana and Wisconsin Department of Transportation and provides real time traffic information, e.g. travel times, congestion information, incidents, and so on as text, image and video data format.

A “detector record” was used that is gathered from loop sensors installed in highways. The detector records are provided by this site as XML data, and they contain a data set of records, each of which consists of update time of the record, sensor device unique id, velocity, number of vehicles per lane per hour and etc.

In order to generate evaluation data for one road segment, the records generated by the sensor at the end of a road segment on highway I90 in Chicago were downloaded, for the period 6 AM to 8 AM on Tuesday May 22, 2007. The data in this period involves congestion and non-congestion situations and the total number of vehicles that ran over the sensor was 6495. The sequence is {(tᵢ, vₘᵢ, rᵢ), (tᵢ₊₁, vₘᵢ₊₁, rᵢ₊₁), . . . }, where the format of each record is as follows:
tᵢ [sec] is the update-time of the record. A record is generated every minute.
vₘᵢ [m/s] is the average velocity of the vehicles running over the loop sensor between tᵢ and tᵢ₊₁.
rᵢ [vehicles/lane/sec] is the number of vehicles per lane passing over the loop detector at tᵢ

Based on this set of records the following information was computed: how many vehicles went through the end of the road segment, at what time each one went through, and what was the speed of the vehicle at that time. In other words, a vehicles-sequence was generated; each vehicle in the sequence is a pair consisting of the vehicle's sensor (i.e. end-segment) crossing time, and its velocity at that time.

Procedure of the Simulation

This subsection describes how a simulation run was conducted. The symbols used are described in a Definition of Terms section listed below.

The input to each simulation run is as follows:
the vehicles-sequence s (see last subsection),
a velocity threshold T used in the transmission rule,
a server delay τ which is fixed for the duration of the simulation.
an update policy (deterministic or randomized)

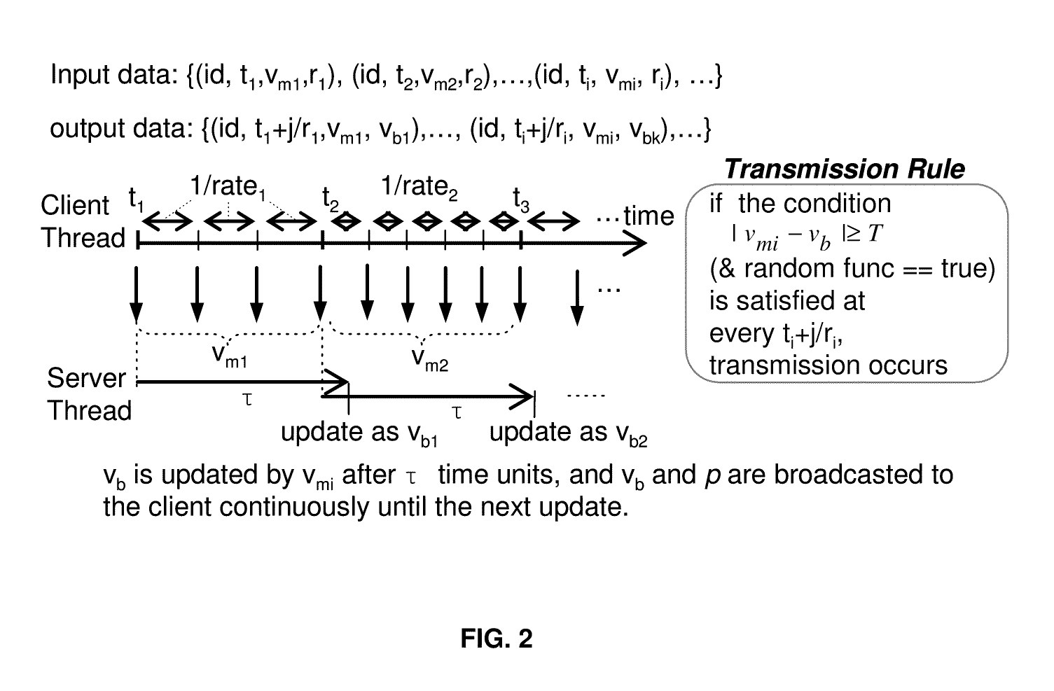

The simulation is executed by two threads, the server thread, and the client thread. The procedure of the simulation is shown in FIG. 2. The server thread keeps receiving the velocities vₘᵢ sent by the client thread and updates v_{b} by vₘᵢ after the server delay. Then the updated v_{b} is used for continuous broadcasting to the client thread until the next update.

In the case of the deterministic policy, the client thread is executed as follows. Each FCD vehicle 704 sends its velocity vₘᵢ to the server 702 at the time it crosses the end of the road segment (the timing is: every tᵢ+j/rᵢ during tᵢ and tᵢ₋₁), if the transmission rule |vₘᵢ−v_{b}|. T is satisfied; where v_{b} is the speed broadcasted by the server 702 at the crossing time. T is the speed threshold that is used in the transmission rule.

The differences of the randomized policy from the deterministic policy are as follows. First, the condition [the randomization function is true (i.e. the result of the toss of a coin with probability p is heads)] is added to the transmission rule. Second, the server 702 broadcasts to the client thread not only v_{b}, but also the optimized probability p. The calculation of the probability p is executed as explained in subsections 3.2 and 3.3.

Finally, the simulation output data is as follows. The vehicles thread outputs a record that consists of (time-of-sensor-crossing, vₘ, v_{b}, and transmission-flag) when each FCD vehicle 704 runs through the end of the segment. The flag indicates whether or not a transmission from the FCD vehicle 704 to the server 702 occurs at the time-of-sensor-crossing. The number of times a transmission occurs is counted using the transmission-flag. The simulation was executed for these ranges of parameters: T={0.1, 0.5, 1, 2, 3, 4, 5, 6, 7}[m/s], τ={60, 120, 180, 240, 300}[sec], V=34.8[m/s], d=0.0217[vehicles/m], U=0.05. The size of the sliding window used to determine the size of the next Δ is five.

Comparison of the Two Update Policies

A comparison was made between the deterministic policy and the randomized policy by using two values that are measured during a 2-hour execution of simulations. One is the communication cost, namely, the total number of transmissions from FCD vehicles 704 to the server 702 which occurred during the simulation. The other is the average error, which is calculated from the difference between the velocity of road segment and the broadcasted velocity from the server 702. Specifically, the average error for a simulation run is calculated as follows. For each second of the simulation we calculate the absolute value of the difference between the broadcast velocity and the measured velocity. Then these values are summed over all seconds of the simulation (7200), and divide the sum by 7200.

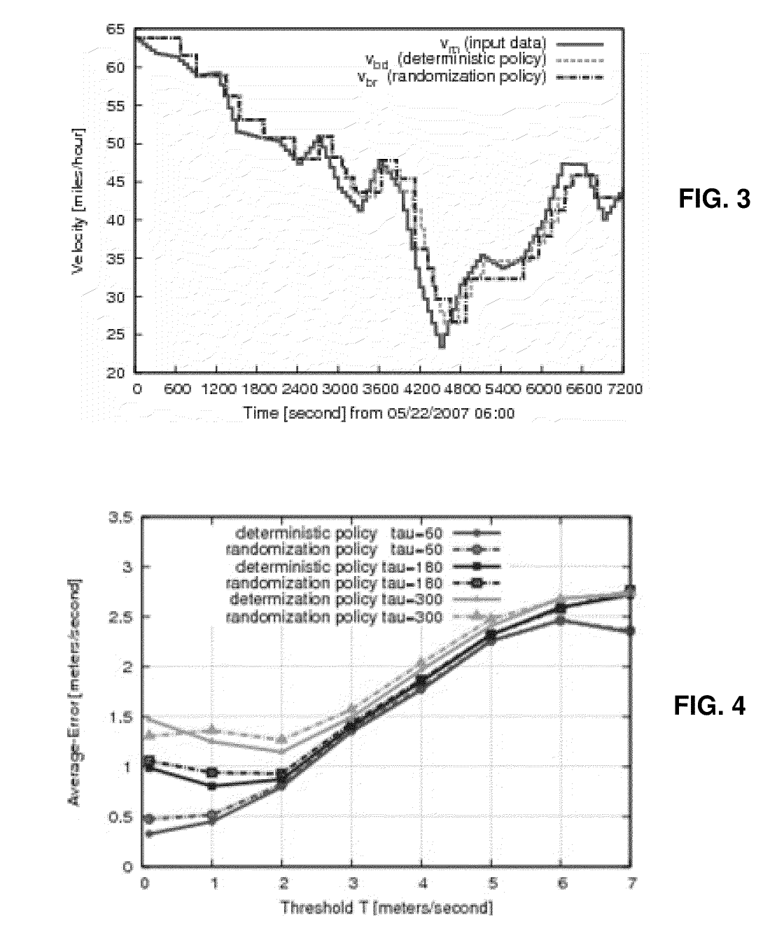

FIG. 3 shows the measured velocity and broadcasted velocities of the randomized and deterministic policies. The average error of the deterministic policy is simply the difference between the integral of the measured velocity and the integral of the broadcasted velocity of the deterministic policy; similarly for the randomized policy average error.

Observe that in determining the optimal probability p the uncertainty cost was used, whereas in the evaluation an error was used. The reason is that the error is a better metric of the imprecision, however, the error is unknown to the server 702 in real-time. But the error can be computed given the vehicles sequence generated retroactively using the sensor (loop detector) records.

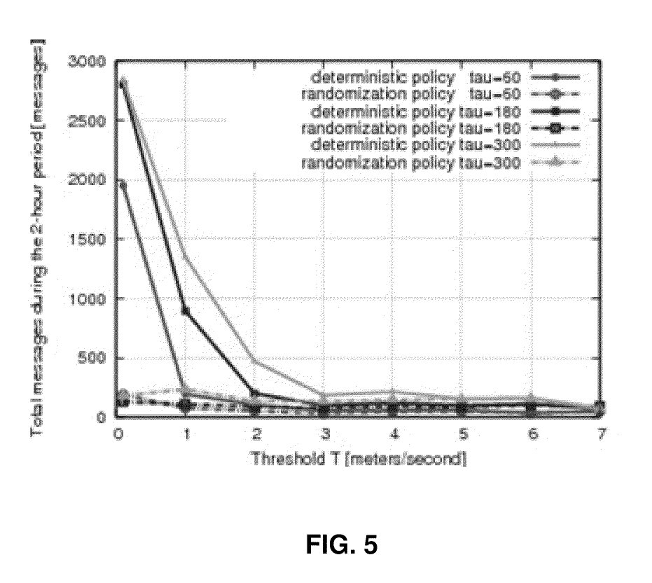

The policies were compared by considering their communication cost for the same error. More precisely, for each value of the error the communication cost of the randomized policy is subtracted from the deterministic one (see FIG. 6). If the difference of the total communication cost between the two policies is greater than zero, then the randomization policy is more efficient than the deterministic policy, because it means that the randomized policy achieves the same accuracy as the deterministic policy, but with less communication. However, the simulation cannot get as a parameter an error value (to produce a value of the communication cost). The parameter of the simulation that induces the error is the transmission threshold T. Thus one can first obtain the error (FIG. 4) and the communication cost (FIG. 5) as a function of T, and then one can compute the difference in communication cost between the two policies, for each given error (see FIG. 6). Furthermore, observe that the results of the comparison may be different for various values of the server delay. Thus the comparison is performed for 5 different values of the server delay, 1 minute, 2 minutes, . . . , 5 minutes.

Simulation Result

FIG. 3 shows the measured velocity (i.e. speed) as a function of time for T=1.0, τ=180, U=0.05. This graph indicates that the measured speed vₘ is changing every minute. Then, the two velocities v_{br}, v_{bd} representing the randomized and deterministic broadcasted velocities, are also shown as a function of time. This graph shows that the updates of v_{br} occur at different times from the updates of v_{bd}. The reason is that in the randomized policy updates are delayed by the randomization function. The broadcasted velocities are also different for the two policies.

Next, relationships are shown among the threshold T, the server delay τ, and the error, during 2-hour execution of the simulation. These relationships are shown in FIG. 4 for each one of the policies. In order to better demonstrate the trends, the curves are shown only for τ=60, 180, and 300 where U=0.05.

According to FIG. 4, the error for a given delay τ varies with the threshold T. In general, the error, expectedly, increases with the threshold T. However, there are exceptions. For example, for τ=300, the minimum error is obtained when the T=2, and further decrease of the threshold increases the error. In general, the error also increases with the server delay τ.

The relationships among the threshold T, the server delay τ, and the total communication cost is shown in FIG. 5. It is observed that for each policy and for each server delay, the total communication cost decreases as the transmission threshold T increases. The reason for this is that the smaller the threshold, the more frequently it is reached. The figure demonstrates another result, namely that the communication cost of the randomized policy is lower than that of the deterministic policy for the same threshold T and server delay τ, especially when T<3. Additionally, when the server delay τ is increased, the communication cost also tends to increase, especially when T is small. The reason is that as the server delay increases, the broadcasted velocity is less accurate, i.e. more frequently different than the measured velocity.

Finally, FIGS. 6A-6B show the difference in communication cost between the randomized policy and the deterministic one, for a given average error (regardless T). More specifically, in FIG. 6A the y-axis is the difference in communication cost (deterministic−randomized), and thus a positive value indicates superiority of the randomized policy, and vice versa, a negative value indicates superiority of the deterministic policy. Each line indicates the communication cost difference for a different server delay.

It can be observed that each line has its own average-error range. The reason is that for larger server delays a lower average error is not achievable. For example, for τ=300 the minimum error is achieved when T=3.0, and lowering T further does not decrease the error (see also FIG. 4).

According to FIG. 6A, each line is greater than zero. This means that in order to achieve the same level of accuracy, the deterministic policy needs more transmissions than the than the randomized policy. It can be observed that this advantage of the randomization policy is independent of the threshold T. Without this observation, one may be tempted to suggest that the effect of the randomized policy can be achieved in the deterministic policy simply by increasing the threshold T. However, FIG. 6A refutes this suggestion by indicating that the advantage of the randomized policy is for a given error, not for a given threshold.

FIG. 6B presents a percentage of the communication cost:

(DeterministicMessageCost−RandomizedMessageCost)*100/DeterministicMessageCost

as a function of the Average Error. The figure indicates the communication cost savings of the randomized policy is indeed significant, representing up to 72% of the communication cost.

The present disclosure addressed the problem of reducing the communication cost in traffic information sharing systems. Such a system is based on Floating Car Data, in which FCD-capable vehicles 704 measure the average velocity on road segments, and then transmit this information to a server 702. In turn, the server broadcasts this information throughout the road network, to be used by vehicles in computing optimal travel routes.

The present disclosure pointed out that the traditional deterministic policy incurs redundant transmissions if the server delay (i.e. the time it takes from the transmission of a velocity update by a vehicle to the server, until this update is propagated to the vehicles in the road network) is significant. The randomized policy was introduced to address this problem. In this policy each vehicle transmits its speed to the server only if the result of the toss of a coin with probability p is “true”.

Then the problem of determining the optimal probability p was addressed. In order to do so the Information Cost Model was introduced to quantify the trade-off between the communication cost and the accuracy of the traffic information sharing system 700. Then the randomized policy was evaluated by comparing it with the conventional deterministic policy. The evaluation and comparison was carried out by using real traffic data collected in one of the Chicago highways. The evaluation shows that randomized policy is superior to the deterministic one, with an advantage up to 72% reduction in communication cost (for the same accuracy). Furthermore, it showed that the effect of the randomized policy cannot be achieved by simply increasing the threshold of the deterministic policy.

From the foregoing descriptions, it would be evident to an artisan with ordinary skill in the art that the aforementioned embodiments can be modified, reduced, or enhanced without departing from the scope and spirit of the claims described below. For example, the randomized policy can be further optimized, for example, by varying other parameters such as U, the ratio between the uncertainty cost and the communication cost. Second, instead of deciding in a probabilistic fashion whether or not a vehicle should transmit the velocity, it is possible to pick the transmission threshold probabilistically. Third, the randomized policy can be adapted to a P2P architecture such as the one proposed in [5].

Fourth, the randomized policy can be compared to a variant in which the server 702 does not revise the broadcasted speed based on every update, but broadcasts the average of speeds from multiple vehicles. In this embodiment the modified randomized policy runs as is, except that the server divides the time into periods during which it averages the received updates.

Other suitable modifications can be applied to the present disclosure. Accordingly, the reader is directed to the claims for a fuller understanding of the breadth and scope of the present disclosure.

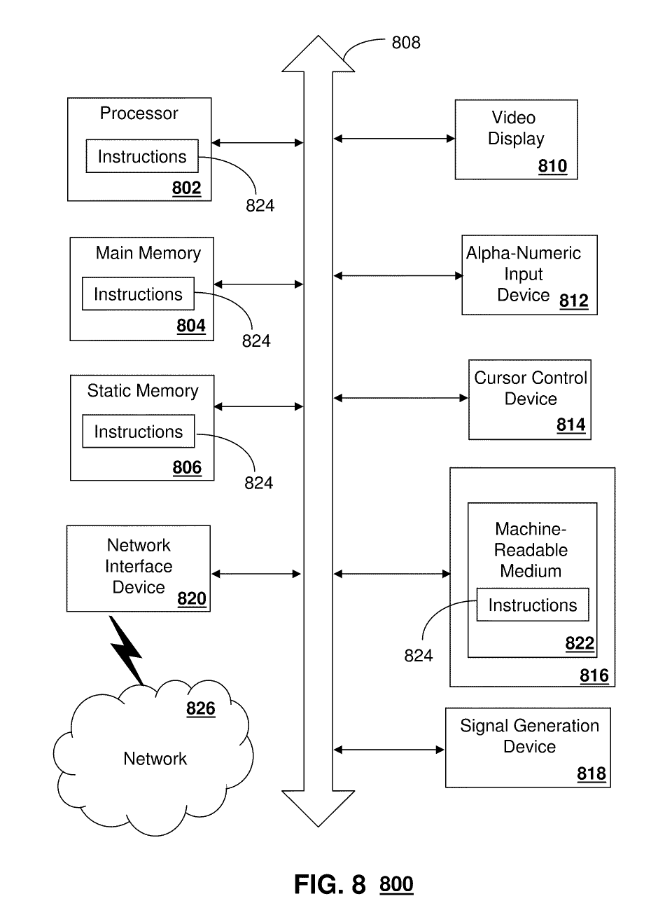

FIG. 8 depicts an exemplary diagrammatic representation of a machine in the form of a computer system 800 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a machine-readable medium 822 on which is stored one or more sets of instructions (e.g., software 824) embodying any one or more of the methodologies or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

### REFERENCES

[1] Turksma, S.: The various uses of floating car data, Road Transport Information and Control, 2000. Tenth Intl. Conference on (Conf. Publ. No. 472), April 2000 pp. 51-55
[2] http://www.premium-club.jp
[3] http://www.vmz-online.de/vmz/
[4] Kerner, B. S., et al: Traffic state detection with floating car data in road networks, Intelligent Transportation Systems, 2005. Proceedings. 2005 IEEE, September 2005, pp. 44-49
[5] S. Goel, et al: Grassroots: A Scalable and Robust Information Architecture. Technical Report DCS-TR-523, Department of Computer Science, Rutgers University, June 2003. http://paul.rutgers.edu/˜gsamir
[6] T. Shinkawa, et al: A Technique for Information Sharing using Inter-Vehicle Communication with Message Ferrying Proceedings of the 2006 International Workshop on Future Mobile and Ubiquitous Information Technologies, (FMUIT'06), pp. 221-225, (May 2006)
[7] Masutani, et, al: Traffic Prediction using Pheromone Model, 12th World Congress on ITS, 2005,
[8] Adachi, et al: Compression Method for Probe Data, Inter-Vehicle P2P Communication Experiment System, ITS World Congress, Nagoya, 2004
[9] R. Horiguchi, et. al: Effective Probe Data Transmittal with Detection of Congestion Pattern, Proc. of 11th World Congress on Intelligent Transport Systems, Nagoya, October 2004
[10] A Civilis, C. S. Jensen, Efficient tracking of moving objects with precision guarantees, Proc. MobiQuitous 2004
[11] Ouri Wolfson, et al: Updating and Querying Databases that Track Mobile Units, Distributed and Parallel Databases, v. 7 n. 3, p. 257-387, July 1999
[12] B. D. Greenshields, “A Study of Traffic Capacity,” Highway Research Board Proc., vol. 14, pp. 448-477 1935
[13] L. Henry, Traffic Flow Theory—A State-of-the-Art Report: Revised Monograph on Traffic Flow Theory, Turner Fairbank Highway Research Center (TFHRC), 2002, http://www.tfhrc.gov/its/tft/tft.htm
[14] B. Xu, and O. Wolfson, “Opportunistic Resource Exchange in Inter-vehicle Ad-hoc Networks”, Proc. of 2004 IEEE Int'l Conf. on Mobile Data Management, pp. 4-12, January 2004.
[15] GCM Travel http://www.gemtravel.com/

Definition of Terms

The notations and definitions used in this disclosure are as follows.
vₘ: Measured velocity of a road segment; it is measured when a vehicle goes through the end of a road segment.
v_{b}: Broadcasted velocity from the server to the vehicles.
T: Threshold of velocity, used in transmission rule to reduce the number of transmissions.
p: The probability used by the randomized policy in combination with the transmission rule.
Δ: In the deterministic policy, the number of time units between two consecutive times the threshold T is exceeded. In the randomized policy, it is the length of the time period from the time a vehicle succeeds in transmitting vₘ to the server, until the threshold T is exceeded the next time (see FIG. 1.).
τ: The number of time units from the update of the server until the vehicles receive the updated velocity. In the simulation, it is the time-length of a server cycle.
K: The number of vehicles running through the end of a road segment during the server delay τ.
U: The cost of a unit of uncertainty per time unit, in messages.
V: The free flow speed, (i.e. uncongested speed) on a road segment.
α: The expected number of time-units from the instance when the measured speed first exceeds the threshold T until a vehicle first transmits the new speed to the server. It depends on the probability p used by the randomized policy.
s: The number of time-unit between two consecutive vehicles.
r: Traffic flow: The number of vehicles per lane per second passing on the road. It is the inverse of s.
d: Jam density: The number of vehicles per unit-length when the traffic is so heavy that it is at a complete standstill.
u: The uncertainty of v_{b}. This value is broadcast by the server in the randomized policy, and it may be the velocity threshold T, or the free flow speed.

What is claimed is:

1. A communication device, comprising a controller to:
receive from a system a broadcasted vehicle velocity;
detect that a difference between a velocity of a vehicle carrying the communication device and the broadcasted vehicle velocity exceeds a threshold; and
determine from a random policy whether to transmit the velocity of the vehicle to the system.

2. The communication device of claim 1, wherein the controller is operable to transmit to the system the velocity of the vehicle responsive to determining from the random policy to perform such transmission.

3. The communication device of claim 1, wherein the random policy conforms to a probability p for determining whether to transmit the velocity of the vehicle to the system.

4. The communication device of claim 3, wherein the probability p is determined from a tradeoff between a communication cost of transmitting the velocity of the vehicle to the system, and an uncertainty cost in calculating the broadcasted vehicle velocity.

5. The communication device of claim 1, wherein the controller is operable to receive the random policy from the system.

6. The communication device of claim 1, wherein the controller is operable to receive the threshold from the system.

7. The communication device of claim 1, wherein the controller is operable to receive from the system at least one of the random policy and the threshold according to a location of the vehicle.

8. The communication device of claim 1, wherein the communication device corresponds to a portable wireless communication device, and wherein the system corresponds to a computing device communicatively coupled to the communicative device over a wireless communication network.

9. The communication device of claim 1, wherein the communication device comprises a global positioning system to determine the velocity of the vehicle.

10. A computing device, comprising a controller to:
broadcast to a plurality of vehicles an observed vehicle velocity associated vehicles traveling on at least one road segment;
receive a velocity of a vehicle traveling the at least one road segment from a communication device responsive to detecting that a difference in the velocity of the vehicle and the observed vehicle velocity exceeds a threshold and satisfies a random policy used by the communication device; and
update the observed vehicle velocity according to the received velocity of the vehicle.

11. The computing device of claim 10, wherein the controller is operable to broadcast to the plurality of vehicles the updated observed vehicle velocity.

12. The computing device of claim 10, wherein the random policy corresponds to a probability for determining whether to transmit the velocity of the vehicle to the system.

13. The computing device of claim 12, wherein the probability is determined from a tradeoff between a communication cost of transmitting the velocity of the vehicle to the computing device, and an uncertainty cost in calculating the observed vehicle velocity.

14. The computing device of claim 10, wherein the controller is operable to transmit the random policy to the communication device.

15. The computing device of claim 10, wherein the controller is operable to transmit the threshold to the communication device.

16. The computing device of claim 10, wherein the controller is operable to transmit to the communication device at least one of the random policy and the threshold according to a location of the vehicle.

17. The computing device of claim 10, wherein the communication device is carried by the vehicle and corresponds to a portable wireless communication device, and wherein the computing device corresponds to a server communicatively coupled to the communication device over a wireless communication network.

18. A computer-readable storage medium, comprising computer instructions to transmit a measured velocity of a vehicle responsive to a random policy.

19. The storage medium of claim 18, comprising computer instructions to transmit the measured velocity of the vehicle responsive to detecting that a difference between the measured velocity of the vehicle and a broadcasted observed vehicle velocity exceeds a threshold, and the random policy directs a transmission of said velocity.

20. The storage medium of claim 18, wherein the storage medium operates in a communication device, and wherein the measured velocity is transmitted to a computing device for updating the broadcasted observed vehicle velocity.

21. A computer-readable storage medium, comprising computer instructions to receive from a device a measured velocity of a vehicle responsive to a random policy that directs said device to transmit the velocity of the vehicle.

22. The storage medium of claim 21, wherein the device corresponds to a communication device carried by the vehicle, and wherein the storage medium operates in a server operable to broadcast an observed vehicle velocity to a plurality of vehicles including the communication device.
